(19) United States
(12) Patent Application Publication
(10) Pub. No.: US 2007/0270096 A1
(43) Pub. Date: Nov. 22, 2007

(54) Wireless communications system, network relay unit and communication method

(75) Inventor: Masanori Nozaki, Osaka (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/704,947

(22) Filed: Feb. 12, 2007

(30) Foreign Application Priority Data
May 18, 2006 (JP) 2006-138502

(51) Int. Cl. H04B 7/14

(52) U.S. Cl. 455/7

(57) ABSTRACT

This invention provides a wireless communications system including: a first sensor unit for obtaining environmental information; a first network relay unit capable of communicating by wireless with the first sensor unit; a second network relay unit capable of communicating by wireless with the first network relay unit; and a second sensor unit capable of communicating by wireless with the second network relay unit. The first network relay unit includes an encapsulation processing part for hiding the sensor information in the relay information transmitted to the second network relay unit, and the second network relay unit includes an encapsulation releasing part for extracting the hidden sensor information from the received relay information.

### CROSS-REFERENCE TO RELATED APPLICATION

The disclosure of Japanese Patent Application No. JP2006-138502 filed on May 18, 2006, entitled “WIRELESS COMMUNICATIONS SYSTEM, NETWORK RELAY UNIT AND COMMUNICATION METHOD”. The contents of that application are incorporated herein by reference in its entirety.

### BACKGROUND OF THE INVENTION

1. Field of the Invention

The present invention relates to a wireless communications system, a network relay unit and a communication method capable of expanding communication area of a sensor network.

2.Description of the Related Art

In recent years, there has been developed a sensor network technology capable of aggregating the environmental information of specific area obtained by each sensor node through the network configured by a plurality of sensor nodes having a communication function, to an information management server. For example, there is known a sensor network technology for realizing the communication function between sensor nodes by a wireless communication (for example, refer to I. F. Akyildiz, W. Su, Y. Sankarasubramaniam, and E. Cayirci, “A survey on sensor networks”, IEEE Communications Magazine, vol. 40, no. 4, pp. 102-114, 2002). Such a technology is the technology for configuring an ad-hoc network by incorporating multiple sensor nodes arranged dispersed and particularly has gotten an attention as an elemental technology for realizing the future ubiquitous society as a technology for facilitating the communication between sensor nodes.

Normally, various restrictions are imposed on the operation condition of the sensor node to obtain the environmental information in many cases according to the environment where the sensor nodes are located. For example, when the sensor nodes are located at the place where the power supply system for supplying a power supply to the sensor nodes is not provided, the battery, etc. with the period of service limited has to be used for each of the sensor nodes. In this case, the sensor nodes are desired to operate for a prolonged period utilizing efficiently the power source such as the battery, etc. with the period of service limited.

For this, the power consumption of the sensor nodes is reduced by controlling the output of the emitted electric waves to extend the power supply's life. Therefore, the longitudinal coverage of the electric waves emitted from the sensor nodes is to be comparatively short approximately at several meters to several tens of meters. Consequently, to establish the sensor network supporting a wide area, multiple sensor nodes have to be provided redundantly.

In addition, there are some cases where, when different sensor networks are connected to each other, the protocol used in the sensor network has to be terminated once to connect by a different protocol (for example, TCP/IP, UDP/IP, etc.). In the environment where such a protocol conversion is required, multiple management domains are required for managing the sensor network to complicate the management.

### SUMMARY OF THE INVENTION

The present invention has been achieved in view of the aforementioned problems. An object of the present invention is to provide a novel and improved wireless communications system, network relay unit and communication method capable of expanding communication area of a sensor network transparently.

To solve the problems, according to an aspect of the present invention, there is provided a wireless communications system including: at least one first sensor unit for obtaining environmental information; a first network relay unit capable of receiving sensor information from the first sensor unit; a second network relay unit capable of receiving relay information from the first network relay unit; and at least one second sensor unit capable of receiving the sensor information from the second network relay unit.

The first network relay unit may include: a sensor unit side receiving part for receiving the sensor information transmitted from the first sensor unit; an encapsulation processing part for hiding the sensor information in the relay information; and a network relay unit side transmitting part for transmitting the relay information with the sensor information hidden to the second network relay unit.

The second network relay unit may include: a network relay unit side receiving part for receiving the relay information transmitted from the first network relay unit; an encapsulation releasing part for extracting the sensor information from the relay information received by the network relay unit side receiving part; and a sensor unit side transmitting part for transmitting the sensor information extracted by the encapsulation releasing part to the second sensor unit.

Further, the wireless communications system may include at least one third network relay unit having a relaying function for receiving the relay information transmitted from the first network relay unit and transmitting to the second network relay unit.

Also, to solve the problems, according to another aspect of the present invention, there is provided a network relay unit capable of receiving sensor information from at least one sensor unit for obtaining environmental information and capable of transmitting relay information to an other network relay unit.

The network relay unit includes: a sensor unit side receiving part for receiving the sensor information transmitted from the sensor unit; an encapsulation processing part for hiding the sensor information in the relay information; and a network relay unit side transmitting part for transmitting the relay information with the sensor information hidden to the other network relay unit.

Further, the network relay unit may include: a connection management table with a list of the sensor unit communicable; and a relay determining part for determining, according to the list described in the connection management table, whether or not the sensor information is to be hidden in the relay information and whether or not the sensor information hidden in the relay information is to be transmitted to the other network relay unit.

Still further, the network relay unit may include: an other area connection management table storing part for recording the list of the other network relay unit capable of receiving the relay information and a list of other sensor unit capable of communicating through the other network relay unit; and a relay processing part for selecting the other network relay unit to which the relay information is transmitted, from the list of the other network relay unit recorded in the other area connection management table storing part.

Also, to solve the problems, according to still another aspect of the present invention, there is provided a communication method by a network relay unit capable of receiving sensor information from at least one sensor unit for obtaining environmental information and capable of transmitting relay information to an other network relay unit.

The communication method includes: a sensor unit side receiving step for receiving the sensor information transmitted from the sensor unit; an encapsulation processing step for hiding the sensor information in the relay information; and a network relay unit side transmitting step for transmitting the relay information with the sensor information hidden to the other network relay unit.

Further, the communication method may include: a table reference step for referring to a connection management table with a list of the sensor unit communicable; and a relay determining step for determining, according to the list described in the connection management table, whether or not the sensor information is to be hidden in the relay information and whether or not the sensor information is to be transmitted to the other network relay unit.

Further, the communication method may include: an other area connection management table referring step for referring to an other area connection management table storing part for recording the list of the other network relay unit capable of receiving the relay information and a list of other sensor unit capable of receiving the sensor information hidden in the relay unit through the other network relay unit; and a relay processing step for selecting the other network relay unit to which the relay information is transmitted, from the list recorded in the other area connection management table.

Further, the communication method may include a table information exchanging step for exchanging the list described in the connection management table and the list described in the other area connection management table between the other network relay unitss.

More specifically, the network relay unit according to the present invention provides a method of transferring the sensor information transparently by using wireless LAN (Local Area Network) having a multihop function. In addition, the network relay unit provides a method of expanding the longitudinal coverage of a transmission frame of the sensor unit by transmitting the frame (sensor information) transmitted from the sensor unit, hiding the frame in a transfer frame (relay information) of the wireless LAN with longer longitudinal coverage of electric waves than that of the sensor network. Further, the network relay unit provides a method of reducing the processing load of the nodes by creating a bypass pathway for a tree-shaped routing by using the wireless LAN having a multihop function in connecting different sensor networks to each other.

According to the present invention, as described above, the bypass pathway that does not go through a parent node can be provided for the tree-shaped routing protocol to reduce the processing load of the parent node and relay nodes.

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments.

FIG. 1 is an explanatory diagram showing a sensor network according to a first embodiment of the present invention.

FIG. 2 is a block diagram showing a configuration of a relay node according to the first embodiment.

FIG. 3 is an explanatory diagram showing a flow of a communication processing according to the first embodiment.

FIG. 4 is an explanatory diagram showing a sensor network according to a second embodiment of the present invention.

FIG. 5 is a block diagram showing a configuration of a relay node according to the second embodiment.

FIG. 6 is an explanatory diagram showing a physical structure of the sensor network shown in FIG. 4.

FIG. 7 is an explanatory diagram showing a logical structure of the sensor network shown in FIG. 4.

FIG. 8 is an explanatory diagram showing a flow of a communication processing according to the second embodiment.

FIG. 9 is an explanatory diagram showing a configuration example of a connection management table.

FIG. 10 is an explanatory diagram showing a configuration example of an other area connection management table.

### DETAILED DESCRIPTION OF THE PREFERRED EMBODIMENTS

Hereinafter, the preferred embodiment of the present invention will be described in reference to the accompanying drawings. Same reference numerals are attached to components having same functions in following description and the accompanying drawings, and a description thereof is omitted.

### First Embodiment

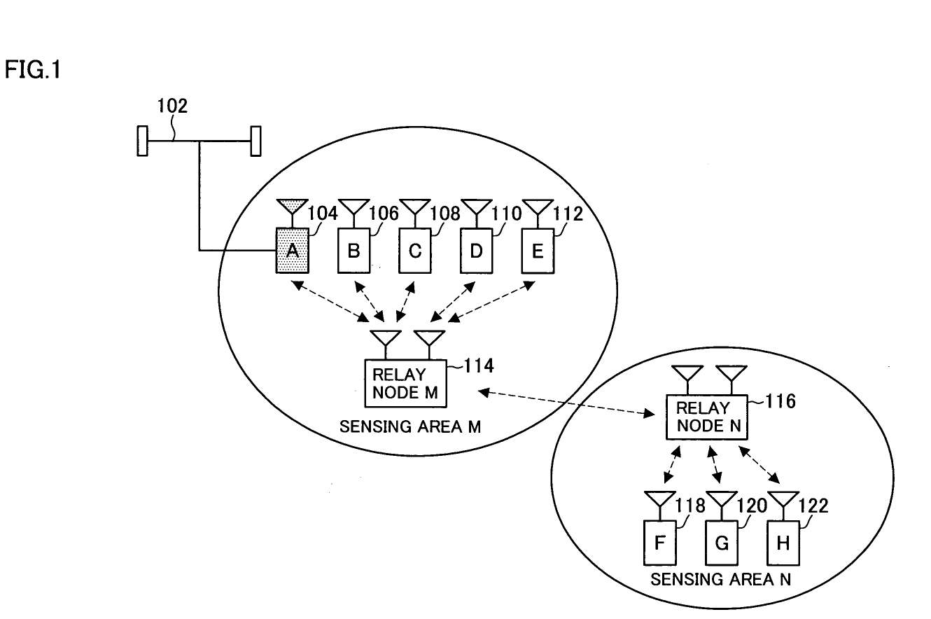

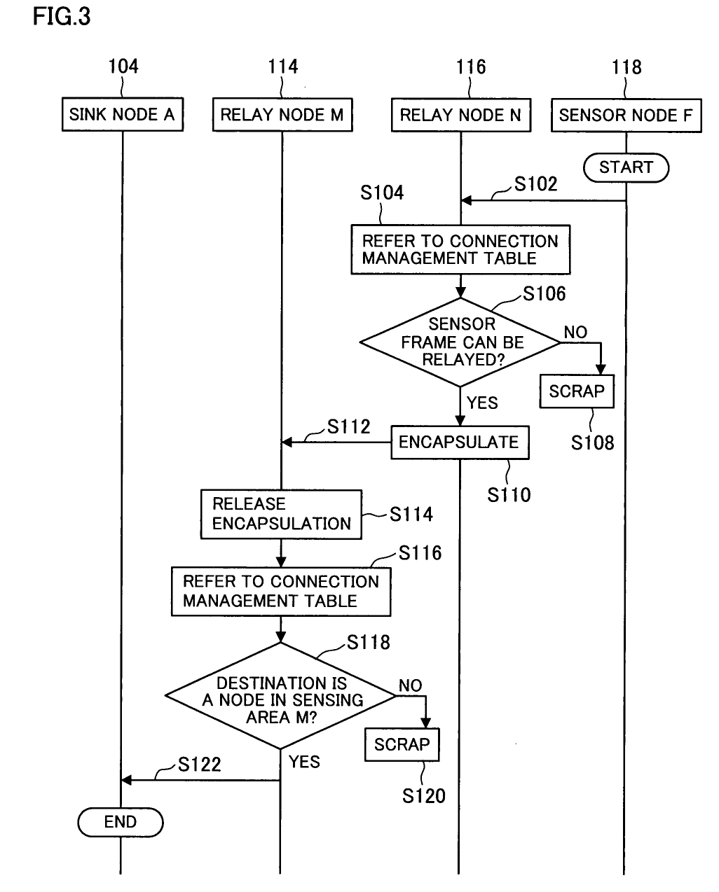

First, there will be described a configuration of a sensor network according to the first embodiment of the present invention, a configuration of a relay node and a flow of a communication processing in reference to FIGS. 1-3.

### (Configuration of Sensor Network)

Prior to a detailed description of the configuration of the sensor network, a configuration of a wireless communications system according to this embodiment will be outlined.

The wireless communications system according to this embodiment is configured by a plurality of sensor units and a plurality of network relay units. Hereinafter, the sensor unit is referred to as a sensor node and the network relay unit as a relay node. The sensor node can perform a wireless communication with other sensor nodes and further with the relay nodes. The relay node can perform a wireless or wired communication with other relay nodes. The relay node can also configure a wireless communication network with at least one sensor node. The relay nodes configure a wired or wireless communication network with other relay nodes. Hereinafter, a wireless communication network area between the sensor nodes and the relay nodes will be referred to as a sensing area and a communication network area between the relay nodes will be referred to as a relay area. The sensor network to be described is configured by a plurality of sensing areas and at least one relay area for connecting the sensing areas to each other. The wireless communications system according to this embodiment can provide a method of transmitting the sensor information transmitted from the sensor node in a certain sensing area, to the sensor node in other sensing area via a communication pathway in the relay area. The wireless communications system can also provide a method of establishing a transparent network with the communication area expanded to a wider area by connecting a plurality of relay nodes in a mesh-like manner.

Hereinafter, the configuration of the sensor network according to this embodiment will be described in reference to drawings. FIG. 1 is an explanatory diagram showing the configuration of the sensor network according to this embodiment. Referring to FIG. 1, the sensor network is mainly configured by a sensing area M and a sensing area N. Inside the sensing area M, there are arranged: a sink node A104; a plurality of sensor nodes 106, 108, 110 and 112 (B, C, D and E); and a relay node M114. Inside the sensing area N, on the other hand, there are arranged a plurality of sensor nodes 118, 120, and 122 (F, G and H) and a relay node N116.

Each of the sensor nodes obtains environmental information in the sensing area M. The environmental information may include a measurement in natural environment such as temperature, humidity, pressure, air volume, rainfall, snowfall, amount of pollen dispersal and radiation dose, or a signal announcing a state of disaster such as fire alarm signal, gas-leak alarm signal, and an earthquake detection signal. Or, when the sensor nodes are for a medical use, the environmental information may include patient information with a real-time monitoring required such as electrocardiogram and electroencephalogram. Further, the sensor node can be used for various purposes, not only for the measurement of natural environment, the assessment of the situation in the disaster site and monitoring of the patient's condition in a medical facility as described above, but also a security control of a house and building, a monitoring of traffic or a management of agricultural product.

In addition, each of the sensor nodes in the sensing area M can perform a wireless communication with the relay node M114. The communication between the sensor nodes is performed through the process of the relay node M114. For example, when information is transmitted from the sensor node D110 to the sensor node B106, the information is once transmitted to the relay node M114. Then the relay node M114 confirms the destination of the information to transfer the information to the sensor node B106. When the distance between the sensor nodes or the distance between the sensor nodes and the sink node is short enough for the electric waves emitted from each node to reach, an ad-hoc network can be configured between the sensor nodes or between the sensor nodes and the sink node.

The sink node A104 aggregates the environmental information obtained by each sensor node. The sink node A104 is connected to a backbone network 102 and transmits the environmental information aggregated from each sensor node to an information management server and a user terminal that are not shown in drawings via the backbone network 102. Therefore, the environmental information obtained by the sensor nodes arranged dispersed is transmitted to a user using the environmental information via the sink node A104. It should be noted that the backbone network 102 may be configured by a wireless communication network or a wire communication network, for example by an arbitrary communication method using optical communications, ADSL (Asymmetric Digital Subscriber Line), power line communication, or satellite communications.

The relay node M114 relays the communication between the sensor nodes and between each sensor node and the sink node A104. Further, the relay node M114 can perform a communication by a wireless LAN with the relay node located inside other sensing area. The relay node M114, as a result, can, for example, transmit the environmental information obtained from each sensor node managed by the relay node M114 to the relay node N116. As described above, in the communication between the relay nodes, the transfer frame received from the sensor node is transmitted encapsulated in the frame of the wireless LAN. In this embodiment, it should be noted that the sensor information transmitted by the sensor nodes is referred to as a sensor frame and the relay information transmitted encapsulated in the frame of the wireless LAN is referred to as a wireless LAN frame.

The components inside the sensing area M have been described. Since the sensor nodes 118, 120 and 122 and the relay node N116 inside the sensing area N have the same function and configuration as the sensor nodes 106, 108, 110 and 112 and the relay node M114 inside the sensing area M, the detailed description thereof will be omitted.

### (Configuration of Relay Node)

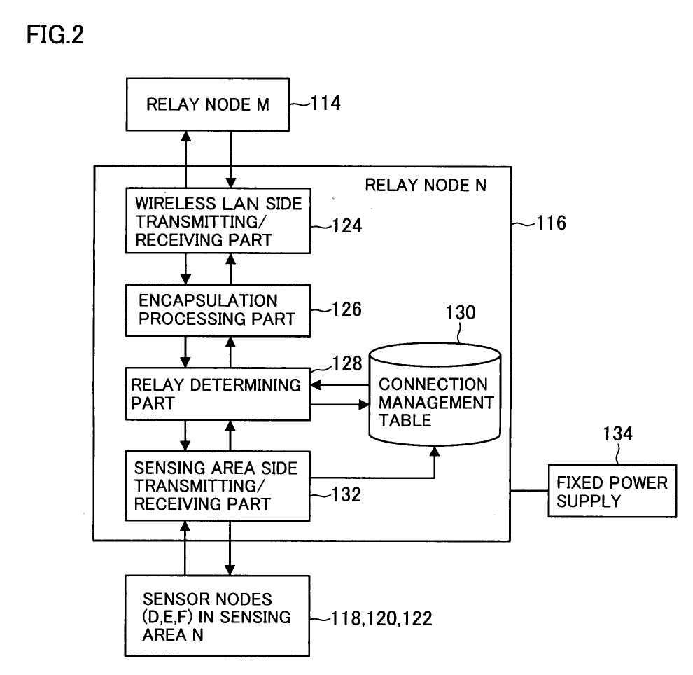

Next, the configuration of the relay node according to this embodiment will be described in reference to FIG. 2. Although the relay node N116 is exemplified for convenience of explanation, the relay node M114 has the same configuration.

The relay node N116 is mainly configured by: a wireless LAN side transmitting/receiving part 124; an encapsulation processing part 126; a relay determining part 128; a connection management table 130; and a sensing area side transmitting/receiving part 132. The relay node N116 may be connected to a fixed power supply 134 capable of supplying a power supply stably for a prolonged period.

The sensing area side transmitting/receiving part 132 performs transmission/reception of the sensor frame among the sensor nodes 118, 120 and 122 arranged in the sensing area N. It should be noted that the sensing area side transmitting/receiving part 132 may be configured by a sensor unit side transmitting part for transmitting the sensor frame to the sensor node and a sensor unit side receiving part for receiving the sensor frame from the sensor node. The connection management table 130 is a database with the list of the sensor nodes 118, 120 and 122 located in the sensing area N managed by the relay node N116. When a new sensor node is added in the sensing area N, the sensing area side transmitting/receiving part 132 having detected the signal emitted by the new sensor node adds the information on the new sensor node to the list held by the connection management table 130.

The relay determining part 128 determines whether the destination of the sensor frame transmitted from the sensing area side transmitting/receiving part 132 is the sensor node located in the sensing area N by referring to the information on the sensor node in the sensing area N recorded in the connection management table 130. If the destination is not the sensor node in the sensing area N, the relay determining part 128 transmits the sensor frame to the encapsulation processing part 126.

The encapsulation processing part 126 encapsulates the sensor frame transmitted from the relay determining part 128. Generally, encapsulation means encapsulating higher-layer data in lower-layer information. In this embodiment, the encapsulation means, for example, encapsulating the sensor frame described by a protocol in the sensing area, in the protocol on the wireless LAN side (for example, TCP/IP, etc.). In other words, the encapsulation means hiding the sensor frame in the frame of the wireless LAN. It should be noted that the encapsulation processing part 126 may be configured by an encapsulation processing part for hiding the sensor frame in a wireless LAN frame and an encapsulation releasing part for extracting the sensor frame from the wireless LAN frame.

The wireless LAN side transmitting/receiving part 124 transmits the sensor frame (wireless LAN frame) encapsulated by the encapsulation processing part 126 to the other relay node M114. On the contrary, the wireless LAN side transmitting/receiving part 124 receives the wireless LAN frame from the other relay node M114 to transmit to the encapsulation processing part 126. The encapsulation processing part 126 extracts the sensor frame from the wireless LAN frame transmitted from the wireless LAN side transmitting/receiving part 124 to transmit to the relay determining part 128. It should be noted that the wireless LAN side transmitting/receiving part 124 may be configured by a network unit side transmitting part for transmitting the wireless LAN frame to the other relay node and a network unit side transmitting part for receiving the wireless LAN frame from the other relay node.

The relay determining part 128 determines whether or not the sensor frame is transmitted to the sensor node in the sensing area N by checking the destination of the sensor frame transmitted from the encapsulation processing part 126 and the sensor node information described in the connection management table 130. In the case of transmitting to the sensor node in the sensing area N, the relay determining part 128 transmits the sensor frame to the sensing area side transmitting/receiving part 132. The sensing area side transmitting/receiving part 132 transmits the sensor frame to the sensor node in the sensing area N.

As above, the configuration of the relay node according to this embodiment has been described by exemplifying the relay node N116. Especially, there have been concretely shown the configuration of transmitting the encapsulated sensor frame from the sensor node in the sensing area N to the other relay node M114 and the configuration of transmitting the sensor frame extracted by releasing the encapsulation of the wireless LAN frame received from the relay node M114 to the sensor node in the sensing area N.

### (Flow of Communication Processing)

Next, the flow of communication processing where the environmental information obtained by the sensor node is transmitted to the sink node. Here, for convenience of explanation, there will be described only the case of transmitting the sensor frame from a sensor node F118 to the sink node A104. As a matter of course, much the same is true on the case where other sensor nodes emit the sensor frame and the destination of the sensor node is not the sink node A104.

An object of the this embodiment, as described above, is to expand the longitudinal coverage of the sensor frame by transmitting the frame transmitted from the sensor node to be encapsulated by the wireless LAN frame. Since the relay nodes M114 and N116, as above, are connected to the fixed power supply, the longitudinal coverage of the electric waves is longer than that of the sensor node. Therefore, the sink node A104 can receive the environmental information obtained by the sensor node located farther by going through the communication pathway between the relay nodes. The flow of communication processing to be exemplified below is a concrete example assuming the situation where the sensor node F118 for emitting the sensor frame is distanced enough from the sink node A104 for receiving the sensor frame and the communication processing has to be performed via the relay nodes M114 and N116.

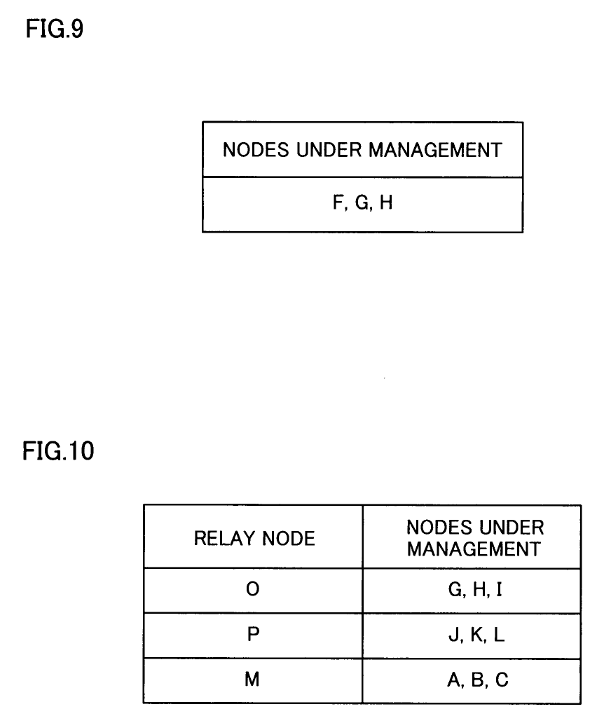

First, the sensor node F118 transmits the sensor frame with the destination set at the sink node A104 to the relay node N116 (S102). The relay node N116 having received the sensor frame refers to the connection management table 130 (S104) and determines whether or not the sensor frame can be relayed (S106). It should be noted that the list of the sensor nodes in the sensing area N managed by the relay node N116 is described in the connection management table 130. The relay node N116, therefore, can judge whether the sensor frame is transmitted to the node in the sensing area N managed by the relay node N116 itself or transmitted to an external node by checking the list of the nodes held by the connection management table 130 and the destination of the sensor frame. For example, the connection management table 130 is configured as shown in the table of FIG. 9.

In this connection management table 130, a user or an administrator can register the information on the node by hand. In addition, the relay node N116 can register the information on the sensor nodes in the sensing area N automatically in the connection management table 130 by monitoring the state of transmission/reception of the sensor frame transmitted from the sensor frame in the sensing area N.

The relay node N116 has the destination of the received sensor frame, for example, described in the connection management table 130 and scraps the sensor frame when the destination is the sensor node in the sensing area N (S108), because the relay node N116 does not have to relay the sensor frame for an external relay node. The relay node N116, on the contrary, encapsulates the sensor frame when the destination of the received sensor frame is the node located outside the sensing area N (S110) to transmit it as the wireless LAN frame to the external relay node M114 (S112).

After receiving the wireless LAN frame, the relay node M114 extracts the hidden sensor frame by releasing the encapsulation (S114). Then the relay node M114 refers to the connection management table where the list of the nodes in the sensing area M managed by the relay node M114 itself is described (S116) to judge whether or not the destination of the extracted sensor frame is the node in the sensing area M (S118). If the destination is not the node in the sensing area M, the relay node M114 scraps the sensor frame (S120). On the contrary, when the destination is the node in the sensing area M, the relay node M114 transmits the sensor frame to the corresponding node. In this example, the relay node M114 transmits the received sensor frame to the sink node A104 (S122).

In the above example, it has been assumed that the relay node has the configuration of scrapping the sensor frame when the destination of the sensor frame received from the sensor node managed by a certain relay node is described in the list in the connection management table. In other words, it has been assumed that the communication among the sensor nodes in the same sensing area is performed without going through the relay node. The communication processing according to this embodiment, however, is not restricted to this example. For example, when the destination of the sensor frame received from the sensor node is the sensor node in the sensing area managed by the relay node itself, the relay node may transmit the sensor frame to the sensor node of the destination. In other words, even the communication among the sensor nodes in the same sensing area may be performed via the relay node.

In the communication processing according to this embodiment, each of the relay nodes checks the destination of the received sensor node and the connection management table to determine whether or not the destination is the node in the sensing area managed by the relay node itself and to perform the relaying or scrapping of the sensor frame. With such a configuration, the environmental information obtained by each of the sensor nodes can be aggregated from the sensor nodes located in a wide area to the sink node. Also in transmitting the sensor frame from one sensor node to another sensor node, it is not necessary to go through the sink node and the sensor frame can be transmitted directly from the one sensor node or from the relay node.

### Second Embodiment

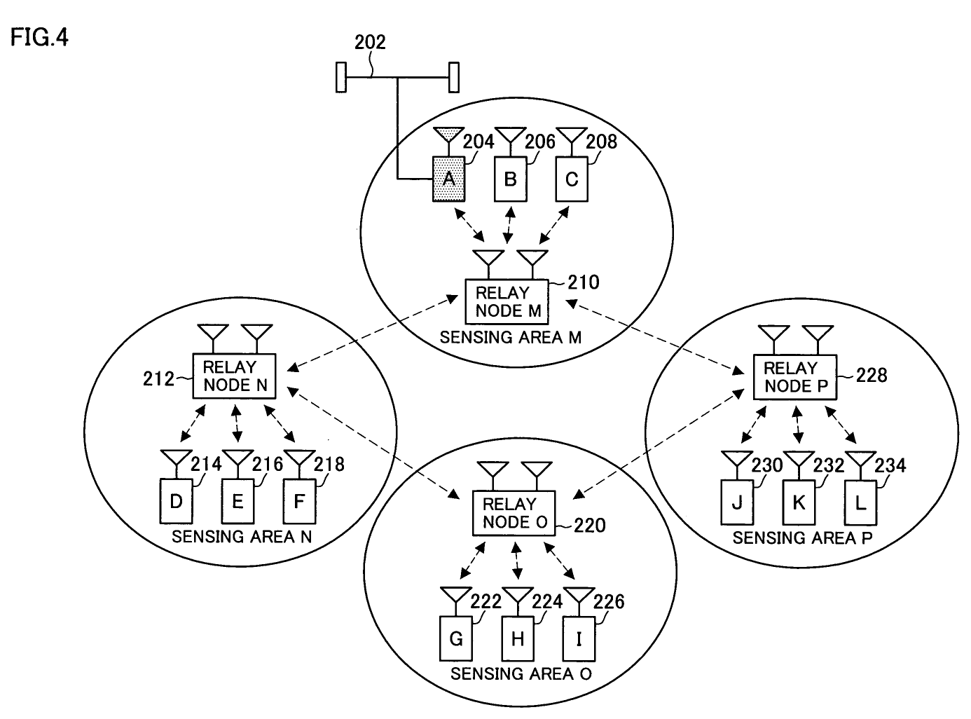

Next, there will be described a configuration of a sensor network according to the second embodiment of the present invention, a configuration of a relay node and a flow of a communication processing in reference to FIGS. 4-8.

### (Configuration of Sensor Network)

FIG. 4 is an explanatory diagram showing the configuration of the sensor network according to the second embodiment of the present invention. Referring to FIG. 4, the sensor network is mainly configured by a sensing area M, a sensing area N, a sensing area O and a sensing area P. Inside the sensing area M, there are arranged: a sink node A204; a plurality of sensor nodes 206 and 208 (B and C); and a relay node M210. Inside the sensing area N, there are arranged a plurality of sensor nodes 214, 216, and 218 (D, E and F) and a relay node N212. Inside the sensing area O, there are arranged a plurality of sensor nodes 222, 224 and 226 (G, H and I) and a relay node O220. Inside the sensing area P, further, there are arranged a plurality of sensor nodes 230, 232, and 234 (J, K and L) and a relay node P228.

Each of the sensor nodes in the sensing area M can perform a wireless communication with the relay node M210. The communication between the sensor nodes or between the sensor nodes and the sink node A204 may be performed through the process of the relay node M210. It should be noted that when the distance between the sensor nodes or the distance between the sensor nodes and the sink node A204 is short enough for the electric waves emitted from each to reach, an ad-hoc network may be configured between the sensor nodes or between the sensor nodes and the sink node A204.

The sink node A204 aggregates the environmental information obtained by each sensor node. The sink node A204 is connected to a backbone network 202 and transmits the aggregated environmental information to an information management server and a user terminal that are not shown in drawings via the backbone network 202.

The relay node M210 relays the communication between the sensor nodes and between each sensor node and the sink node A204. Further, the relay node M210 can perform a communication by a wireless LAN with the relay node located inside other sensing area. The relay node M114, in other words, can transmit the environmental information obtained by each sensor node managed by the relay node M210 to, for example, the relay node N212 in the sensing area N.

The internal components inside the sensing area M have been described. Since the sensor nodes and the relay nodes inside the sensing areas N, O and P have substantially the same function and configuration as the sensor nodes and the relay node inside the sensing area M, the detailed description thereof will be omitted.

The difference between the first embodiment and the second embodiment is that the wireless LAN frame can be transmitted from the relay node O220 via, for example, the relay node N212 to the relay node M210 for relaying the information to the sink node A204. Even with a relay node with comparative long longitudinal coverage of the electric waves, the wireless communication between the relay nodes cannot be performed in some cases and a method of establishing a communication pathway via other relay node is required. According to this embodiment, an effective communication method between the sensor nodes that are distanced can be provided on the assumption of such a condition.

### (Configuration of Relay Node)

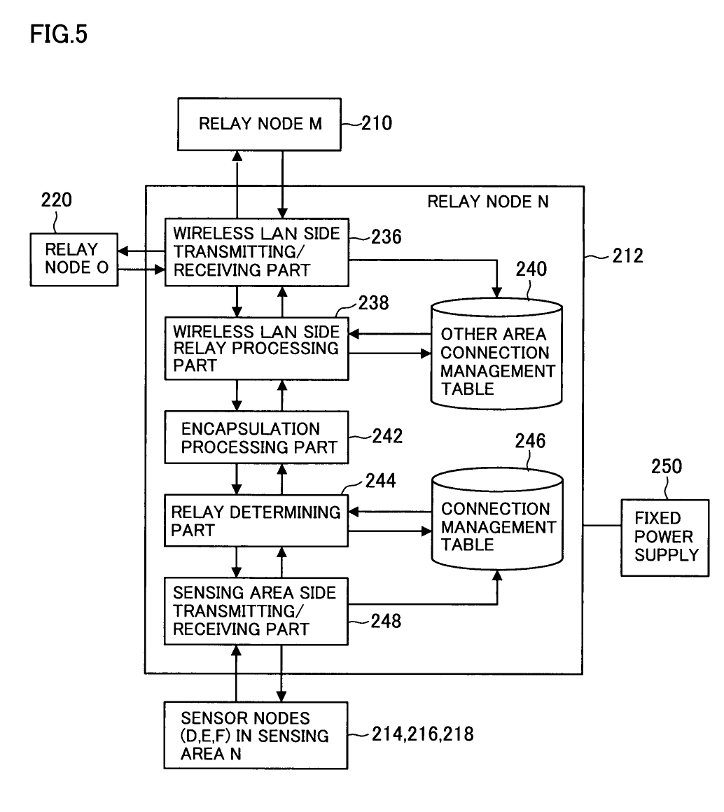

Next, the configuration of the relay node according to this embodiment will be described in reference to FIG. 5. Although the relay node N212 is exemplified for convenience of explanation, the other relay nodes have the same configurations.

The relay node N212 is mainly configured by: a wireless LAN side transmitting/receiving part 236; a wireless LAN side relay processing part 238; an other area connection management table 240; an encapsulation processing part 242; a relay determining part 244; a connection management table 246; and a sensing area side transmitting/receiving part 248. The relay node N212 may be connected to a fixed power supply 250 capable of supplying a power supply stably and continually.

The sensing area side transmitting/receiving part 248 performs transmission/reception of the sensor frame among the sensor nodes arranged in the sensing area N. The connection management table 246 is a database with the list of the information on the sensor nodes 214, 216 and 218 in the sensing area N managed by the relay node N212. When a new sensor node is added in the sensing area N, the sensing area side transmitting/receiving part 248 having detected the signal emitted by the new sensor node adds the information on the new sensor node to the list held by the connection management table 246.

The relay determining part 244 determines whether the destination of the sensor frame transmitted from the sensing area side transmitting/receiving part 248 is the sensor node located in the sensing area N by referring to the information on the sensor node in the sensing area N recorded in the connection management table 246. If the destination is not the sensor node in the sensing area N, the relay determining part 244 transmits the sensor frame to the encapsulation processing part 242 so as to transmit the sensor frame to the other relay nodes. The encapsulation processing part 242 encapsulates the sensor frame transmitted from the relay determining part 244.

The other area connection management table 240 stores the information on the sensor node or the sink node in other sensing area. As shown in the table of FIG. 10, for example, there are stored the information on the relay node managing the nodes of each sensing area and the information on the nodes managed by the relay node, associated with the information on the node. Referring to FIG. 10, the nodes A, B and C exist in the sensing area M managed by the relay node M210. Therefore, the relay node N212 can select a proper relay point easily by checking the destination of the wireless LAN frame to be transmitted and the information in the other area connection management table 240.

The wireless LAN side relay processing part 238 refers to the information on the list in the other area connection management table 240 to judge whether or not the destination of the wireless LAN frame to be transmitted is described in the information on the list. If the destination of the wireless LAN frame is described in the information on the list, the relay node on the destination's side is specified and the wireless LAN frame is transmitted to the wireless LAN side transmitting/receiving part 236. On the contrary, if the destination of the wireless LAN frame is not described in the information on the list, the wireless LAN frame is scrapped.

The wireless LAN side transmitting/receiving part 236 transmits the wireless LAN frame received from the wireless LAN side relay processing part 238 to the other relay node. On the contrary, the wireless LAN side transmitting/receiving part 236 transmits the wireless LAN frame received from the other relay node to the wireless LAN side relay processing part 238.

The wireless LAN side relay processing part 238 refers to the other area connection management table 240 when the wireless LAN frame is transmitted from the wireless LAN side transmitting/receiving part 236. At this time, when the destination of the received wireless LAN frame is described in the other area connection management table 240, the wireless LAN side relay processing part 238 specifies a proper other relay node to return the wireless LAN frame to the wireless LAN side transmitting/receiving part 236 without transmitting the wireless LAN frame to the encapsulation processing part 242. When the destination of the wireless LAN frame is not described in the other area connection management table 240, the wireless LAN frame is transmitted to the encapsulation processing part 242.

The encapsulation processing part 242 extracts the sensor frame from the wireless LAN frame transmitted from the wireless LAN side relay processing part 238 to transmit to the relay determining part 244. The relay determining part 244 determines whether or not the sensor frame is transmitted to the sensor node in the sensing area N by checking the destination of the sensor frame transmitted from the encapsulation processing part 242 and the sensor node information described in the connection management table 246. In the case of transmitting to the sensor node in the sensing area N, the relay determining part 244 transmits the sensor frame to the sensing area side transmitting/receiving part 248. The sensing area side transmitting/receiving part 248 transmits the sensor frame to the sensor node in the sensing area N.

As above, the configuration of the relay node according to this embodiment has been described by exemplifying the relay node N212. Especially, there have been concretely shown the configuration of transmitting the encapsulated sensor frame from the sensor node in the sensing area N to the other relay node, the configuration of transmitting the sensor frame extracted by releasing the encapsulation of the wireless LAN frame received from the other relay node to the sensor node in the sensing area N and the configuration of relaying the wireless LAN frame received from the other relay node to still another relay node.

### (Flow of Communication Processing)

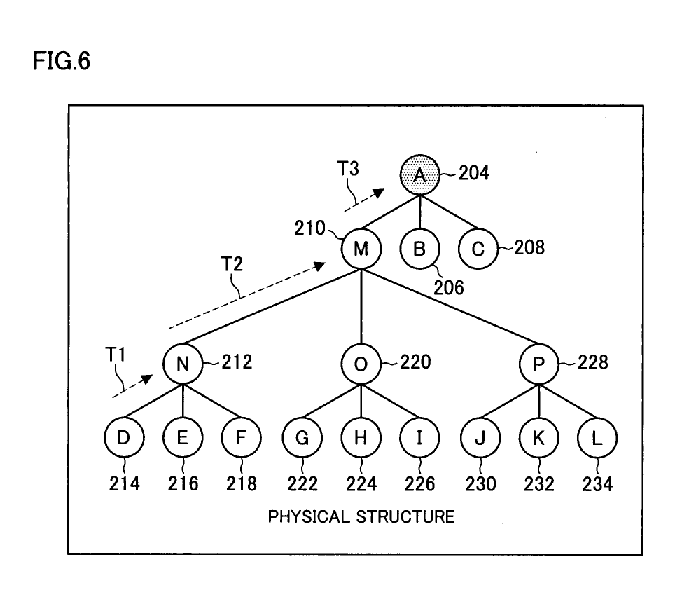

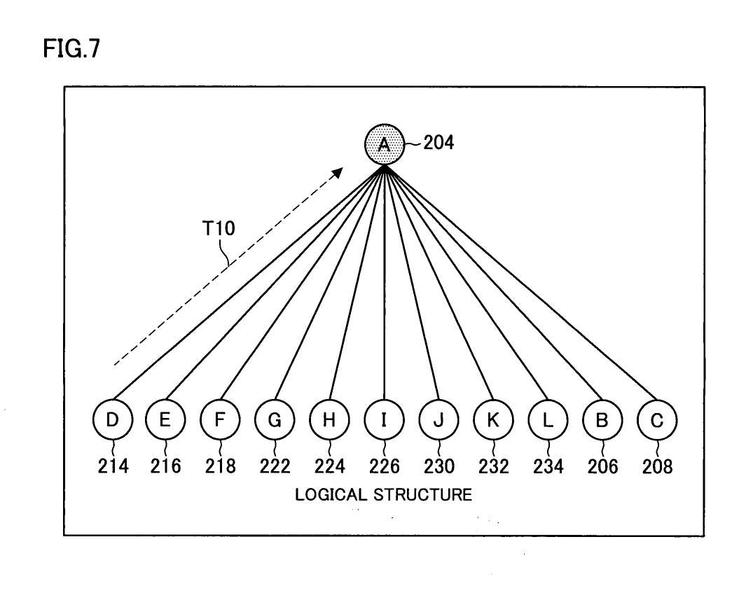

Next, the flow of communication processing according to this embodiment will be described in detail by giving a concrete example. First, prior to this description, the network configuration in FIG. 4 is conceptually organized to weigh the flow of normal communication processing and the flow of communication processing according to this embodiment in reference to FIGS. 6 and 7. As a matter of course, the flow of communication processing according to this embodiment can be realized by the above network configuration and the configuration of relay node.

First, in reference to an explanatory diagram showing a physical structure of the network in FIG. 6, the flow of communication processing will be organized in brief. It should be noted that circles in FIG. 6 indicate each node and alphabets in the circles correspond to the alphabets of each node in FIG. 4. Solid lines indicate the communication pathway between each of the nodes and dashed arrows (T1, T2 and T3) indicate the transmission process of the frame.

As shown in FIG. 6, the physical structure of the network shown in FIG. 4 is a tree structure with the node A as a top and the nodes M, N, O and P as an axis. In a tree-like routing protocol used in a normal sensor network, for example, the frame has to go through the nodes N and M when transmitted from the node D to the node A. Here, when the first embodiment is applied to adopt a relaying means by encapsulation, the nodes N and M can transfer the frame transparently and the node A is regarded as the node capable of reaching at one hop as shown in FIG. 7. Therefore, the transmission processes T1, T2 and T3 in FIG. 6 from the node D to the node A can be regarded as a transmission process T10 at one hop as shown in FIG. 7.

Referring to FIG. 6 again, when a normal routing protocol is used in transmitting the frame from the node D to the node L, the frame reaches the node A via the nodes N and M and then reaches the node L via the nodes M and P. In other words, when the frame is transmitted and received between the nodes at the bottom layer, the frame has to go through the node A without exception. Consequently, in transmitting one frame, since one node has to transmit and process the same frame repetitively, the nodes on the way have to have an extra load. However, the use of the relay node according to this embodiment provides a method of forming a bypass pathway for a tree-like communication pathway to reduce the load of the nodes on the way.

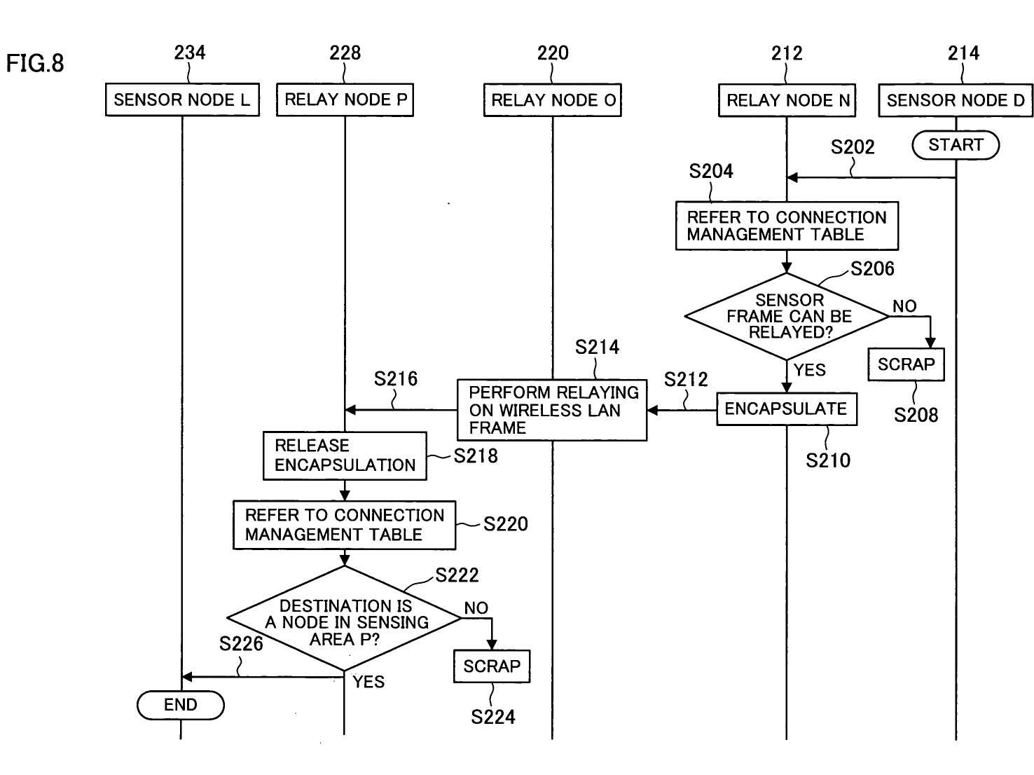

Here, the frame transmission process via such a bypass pathway will be described in reference to FIG. 8. FIG. 8 is an explanatory diagram showing the transmission process of the sensor frame emitted from a sensor node D214 to a sensor node L234 via the relay nodes N212, O220 and P228. In this example, the destination of the sensor frame is the sensor node L234 under the management of the relay node P228. Under this condition, the flow of communication processing will be described.

First, the sensor node D214 transmits the sensor frame to the relay node N212 (S202). It should be noted that the sensor frame is not transmitted to be received only by the relay node N212 and can be received by other sensor frames in the sensing area N. As a matter of course, each sensor node having received the sensor frame scrap the sensor frame when the received sensor frame is not transmitted to the node on its own.

The relay node N212 refers to the connection management table and then refers to the other area connection management table (S204) after confirming that the destination of the sensor frame received from the sensor node D214 is not the sensor node in the sensing area managed by the relay node N212 itself. As described above, there are described, in the other area connection management table, the list of information on the relay node capable of relaying and the list of information on the sensor nodes or the sink nodes in the relay node. Accordingly, it is judged whether or not the relay node N212 can relay the sensor frame by checking the destination of the sensor node and the list in the other area connection management table (S206). In other words, it is judged whether or not the sensor frame is transmitted to the node managed by the relay node N212 or an external node. In the case of the external node, the relay node N212 specifies the relay node managing the sensing area among other relay nodes with which the relay node N212 can communicate, to determine the node in this sensing area as the destination of the sensor frame.

If the relaying cannot be performed, the relay node N212 scraps the sensor frame (S208). Since the destination of the sensor frame is the sensor node L234 in the relay node P228, the relay node N212 encapsulates the sensor frame to make the wireless LAN frame (S210). At this time, the destination of the wireless LAN frame is set at the relay node P228. As shown in FIG. 4, since the relay node N212 cannot communicate directly with the relay node P228, the relay node N212 transmits the wireless LAN frame to the relay node O220 for relaying this communication (S212).

Next, the relay node O220 judges whether or not the relaying can be performed by referring to the destination of the wireless LAN frame received from the relay node N212 (S214). In this case, since the relay node O220 has the communication pathway to the relay node P228, it is judged that the relaying can be performed and the wireless LAN frame is transferred to the relay node P228 (S216). It should be noted that the judgment of relaying is performed by referring to the other area connection management table held by the relay node O220. In other words, since the list of the relay nodes connected by the wireless LAN directly or indirectly and the nodes managed by the relay node is described in the other area connection management table, there can also be performed the relaying of the wireless LAN frame which is not transmitted to the node in its own sensing area, by checking the destination of the received wireless LAN frame and the list.

Next, the relay node P228 confirms that the received wireless LAN frame has been transmitted to the relay node P228 itself to release the encapsulation of the wireless LAN frame and to extract the hidden sensor frame (S218). Then the relay node P228 refers to the connection management table to confirm that the sensor frame is transmitted to the node in the sensing area P managed by the relay node P228 itself (S222). If the sensor frame is not transmitted to the node in the sensing area P managed by the relay node P228, the sensor frame is scrapped (S224). In this example, since the destination of the sensor frame is the sensor node L234 in the sensing area P, the relay node P228 transmits the sensor frame to the sensor node L234 (S226).

As above, there has been described the process of transmitting the sensor frame emitted from the sensor node D214 to the sensor node L234 via each relay node. As this, each relay node holds the other area connection management table, checks the contents of the other area connection management table and the destination of the wireless LAN frame to be transmitted and received and relays the wireless LAN frame, and thereby the bypass pathway capable of transmitting the frame without going through the sink node A204 at the top of the physical structure is formed. With such a configuration, it can be achieved not only that the load of each relay node is reduced, but also that the traffic of the whole network is made efficient, and thereby more efficient and low-power-consumption sensor network can be realized.

Although the preferred embodiment of the present invention has been described referring to the accompanying drawings, the present invention is not restricted to such examples. It is evident to those skilled in the art that the present invention may be modified or changed within a technical philosophy thereof and it is understood that naturally these belong to the technical philosophy of the present invention.

What is claimed is;

1. A wireless communications system comprising: at least one first sensor unit for obtaining environmental information; a first network relay unit capable of receiving sensor information from the first sensor unit; a second network relay unit capable of receiving relay information from the first network relay unit; and at least one second sensor unit capable of receiving the sensor information from the second network relay unit, wherein,
the first network relay unit comprises:
a sensor unit side receiving part for receiving the sensor information transmitted from the first sensor unit;
an encapsulation processing part for hiding the sensor information in the relay information; and
a network relay unit side transmitting part for transmitting the relay information with the sensor information hidden to the second network relay unit, and
the second network relay unit comprises:
a network relay unit side receiving part for receiving the relay information transmitted from the first network relay unit;
an encapsulation releasing part for extracting the sensor information from the relay information received by the network relay unit side receiving part; and
a sensor unit side transmitting part for transmitting the sensor information extracted by the encapsulation releasing part to the second sensor unit.

2. The wireless communications system according to claim 1, further comprising at least one third network relay unit having a relaying function for receiving the relay information transmitted from the first network relay unit and transmitting to the second network relay unit.

3. A network relay unit capable of receiving sensor information from at least one sensor unit for obtaining environmental information and capable of transmitting relay information to an other network relay unit, the network relay unit comprising:
a sensor unit side receiving part for receiving the sensor information transmitted from the sensor unit;
an encapsulation processing part for hiding the sensor information in the relay information; and
a network relay unit side transmitting part for transmitting the relay information with the sensor information hidden to the other network relay unit.

4. The network relay unit according to claim 3, further comprising:
a connection management table with a list of the sensor unit communicable; and
a relay determining part for determining, according to the list described in the connection management table, whether or not the sensor information is to be hidden in the relay information and whether or not the sensor information hidden in the relay information is to be transmitted to the other network relay unit.

5. The network relay unit according to claim 3, further comprising:
an other area connection management table storing part for recording the list of the other network relay unit capable of receiving the relay information and a list of other sensor unit capable of communicating through the other network relay unit; and
a relay processing part for selecting the other network relay unit to which the relay information is transmitted, from the list of the other network relay unit recorded in the other area connection management table storing part.

6. The network relay unit according to claim 4, further comprising:
an other area connection management table storing part for recording the list if the other network relay unit capable of receiving the relay information and a list of other sensor unit capable of communicating through the other network relay unit; and
a relay processing part for selecting the other network unit to which the relay information is transmitted, from the list of the other network relay unit recorded in the other area connection management table storing part.

7. A communication method by a network relay unit capable of receiving sensor information from at least one sensor unit for obtaining environmental information and capable of transmitting relay information to an other network relay unit, the communication method comprising:
a sensor unit side receiving process for receiving the sensor information transmitted from the sensor unit;
an encapsulation processing process for hiding the sensor information in the relay information; and
a network relay unit side transmitting process for transmitting the relay information with the sensor information hidden to the other network relay unit.

8. The communication method according to claim 7, further comprising:
a table reference process for referring to a connection management table with a list of the sensor unit communicable; and
a relay determining process for determining, according to the list described in the connection management table, whether or not the sensor information is to be hidden in the relay information and whether or not the sensor information is to be transmitted to the other network relay unit.

9. The communication method according to claim 7, further comprising:
an other area connection management table referring process for referring to an other area connection management table storing part for recording the list of the other network relay unit capable of receiving the relay information and a list of other sensor unit capable of receiving the sensor information hidden in the relay unit through the other network relay unit; and
a relay processing process for selecting the other network relay unit to which the relay information is transmitted, from the list recorded in the other area connection management table.

10. The communication method according to claim 8, further comprising:
an other area connection management table referring process for referring to an other area connection management table storing part for recording the list of the other network relay unit capable of receiving the relay information and a list of other sensor unit capable of receiving the sensor information hidden in the relay unit through the other network relay unit; and
a relay processing process for selecting the other network relay unit to which the relay information is transmitted, from the list recorded in the other area connection management table.

11. The communication method according to claim 9, further comprising a table information exchanging process for exchanging the list described in the connection management table and the list described in the other area connection management table between the other network relay units.

12. The communication method according to claim 10, further comprising a table information exchanging process for exchanging the list described in the connection management table and the list described in the other area connection management table between the other network relay units.
